(19) United States
(12) Patent Application Publication
(10) Pub. No.: US 2009/0171975 A1
(43) Pub. Date: Jul. 2, 2009

(54) METHOD AND SYSTEM FOR TRACKING CARBON CREDITS AND OTHER CARBON VALUATION UNITS

(76) Inventors: Robert S. McConnell, Shakopee, MN (US); Paul Hepperla, Carver, MN (US); Daniel T. Johnson, Medina, MN (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(21) Appl. No.: 12/328,572

(22) Filed: Dec. 4, 2008

Related U.S. Application Data
(63) Continuation-in-part of application No. 12/252,265, filed on Oct. 15, 2008.
Application No. 12/252,265 is a continuation-in-part of application No. 12/042,917, filed on Mar. 5, 2008.
Application No. 12/042,917 is a continuation-in-part of application No. 11/744,713, filed on May 4, 2007, now Pat. No. 7,440,871.
(60) Provisional application No. 60/893,261, filed on Mar. 6, 2007.

(51) Int. Cl. G06F 17/30

(52) U.S. Cl. 707/10; 707/200; 707/E17.01; 707/E17.009; 707/E17.032

(57) ABSTRACT

The various embodiments disclosed herein relate to systems and methods for tracking and/or managing carbon reduction activities and the resulting carbon valuation units. Certain embodiments relate to methods or systems having at least a central processor, a database, and carbon credit calculation software configured to calculate a total number of carbon credits based on a carbon reduction activity. Other embodiments can also include identification software configured to assign a unique identification to each carbon credit or portion thereof. Various other components and embodiments are also disclosed.

### CROSS-REFERENCE TO RELATED APPLICATIONS

This application is a continuation-in-part of U.S. application Ser. No. 12/252,265, filed on Oct. 15, 2008 and entitled “Method and System for Tracking and Managing Destruction, Reconstitution, or Reclamation of Regulated Substances,” which is a continuation-in-part of U.S. patent application Ser. No. 12/042,917, filed Mar. 5, 2008, entitled “Method and System for Tracking and Managing Various Operating Parameters of Enterprise Assets,” which is a continuation-in-part of U.S. patent application Ser. No. 11/744,713, filed May 4, 2007, entitled “Method and System for Tracking and Reporting Emissions,” which claims priority to U.S. patent application Ser. No. 60/893,261, filed Mar. 6, 2007, entitled “Emissions Tracking and Reporting,” all of which are hereby incorporated herein by reference in their entireties.

### FIELD

The field of the various embodiments disclosed herein relates generally to tracking of carbon valuation units and more specifically to systems and methods for tracking and managing carbon reduction activities and the resulting carbon valuation units across sites, enterprises, countries, and/or any markets for the units.

### BACKGROUND

Gases that trap heat in the atmosphere are often called greenhouse gases (GHGs). GHGs are believed to be a significant contributor to the global warming phenomenon. Some GHGs such as carbon dioxide occur naturally and are emitted to the atmosphere through natural processes. Other GHGs are created and emitted solely through human activities. The principal GHGs that enter the atmosphere because of human activities are: carbon dioxide (CO₂), methane (CH₄), nitrous oxide (N₂O), and fluorinated gases such as hydrofluorocarbons, perfluorocarbons, and sulfur hexafluoride. In addition, GHGs can include at least some types of chlorinated gases. Further, various materials containing the same substances as those found in GHGs can also damage the environment.

Many governments are taking steps to reduce GHG emissions and/or environmentally damaging substances or materials through national policies that include the introduction of emissions trading programs, voluntary programs, substance destruction programs, carbon or energy taxes, and regulations and standards on energy efficiency and emissions. As a result of such political and legislative initiatives in the United States and abroad, organizations are increasingly required to track and report their GHG emissions. Such emissions tracking and reporting can be arduous when it must be conducted for a multi-site organization or enterprise which exists across a wide geography. For example, a large retail chain may have hundreds of sites across the United States, with each site containing hundreds of sources of GHG emissions.

The creation of the emissions and materials trading programs has created a market in which companies can trade in carbon valuation units. Thus, companies can create an additional source of profits by reducing their GHG emissions or carbon-based materials. More specifically, a company can reduce its GHG emissions or carbon-based materials, gain carbon valuation units as a result of the reduction, and then sell those credits in the open market for a profit.

Accordingly, there is a need in the art for a system or method for expeditiously and efficiently managing and tracking the carbon credits—or any other type of carbon valuation—including managing and tracking all information about the credit including the carbon reduction activity that created it along with its ownership history, etc. to allow for verification and certification of the credit.

### BRIEF SUMMARY

One embodiment as disclosed herein relates to a network-based carbon credit tracking system. The system has a central processor, a database, a client processor, carbon credit calculation software, identification software, and report software. In this embodiment, the database is configured to store carbon credit information, including at least carbon reduction information relating to each carbon credit or a portion thereof The client processor is configured to allow a user to input or access any portion of the carbon credit information. In addition, the carbon credit calculation software is configured to calculate a total number of carbon credits based on a carbon reduction activity, and the identification software is configured to assign a unique identification to each carbon credit or portion thereof. Further, the report software is configured to generate a report relating to the carbon credit information.

An additional embodiment relates to a network-based carbon credit tracking system. The system has a central processor, a database, carbon credit calculation software, identification software, and report software. In this embodiment, the central processor is in communication with an external system via the computer network, and the database is configured to store carbon credit information. Further, the carbon credit calculation software is configured to calculate a total number of carbon credits based at least in part on a portion of the carbon credit information, and the identification software is configured to assign a unique identification to each carbon credit or portion thereof. In addition, the report software is configured to generate a report relating to the carbon credit information.

Another alternative embodiment relates to a network-based carbon credit tracking system. The system has a central processor, a database, a client processor, carbon credit calculation software, identification software, and report software. The central processor is in communication with an external system via the computer network, and the database is configured to store carbon credit information relating to each carbon credit or each portion thereof being tracked by the system. The carbon credit information includes at least carbon reduction information and ownership information relating to each carbon credit or portion thereof. The client processor is configured to allow a user to input or access any portion of the carbon credit information. The carbon credit calculation software is configured to calculate a total number of carbon credits based on a carbon reduction activity, while the identification software is configured to assign a unique identification to each carbon credit or portion thereof. In addition, the report software is configured to generate a report relating to the carbon credit information.

While multiple embodiments are disclosed, still other embodiments will become apparent to those skilled in the art from the following detailed description, which shows and describes illustrative embodiments of the invention. As will be realized, the invention is capable of modifications in various obvious aspects, all without departing from the spirit and scope of the inventions described herein. Accordingly, the drawings and detailed description are to be regarded as illustrative in nature and not restrictive.

### BRIEF DESCRIPTION OF THE DRAWINGS

FIG. 1 is a flow chart illustrating the operation of a system and method for managing and/or tracking carbon credits, in accordance with one embodiment.

FIG. 2 is a block diagram of a carbon credit tracking and management system configuration, in accordance with one embodiment.

FIG. 3 is a flow chart illustrating a method of generating an emissions report, according to one embodiment.

### DETAILED DESCRIPTION

Various embodiments of methods and systems described herein relate to tracking and/or managing carbon credits or any other tradable carbon unit for a site, an enterprise, and/or for an entire carbon credit market.

As countries and states throughout the world begin to implement various programs and laws to reduce GHG emissions and other GHG and CO2 equivalent materials, it is likely that many will create markets for tradable carbon units of some kind as described in further detail herein. The systems and methods described herein will provide for tracking and management of such carbon units, including verification of such units.

The systems and methods described herein provide for tracking and/or managing any type of carbon valuation. For purposes of this application, “carbon valuation” is intended to mean any form of value assigned to GHG emissions, a reduction thereof, or any other reduction in CO₂ equivalents (as defined elsewhere herein), such as carbon credits or a carbon tax or any other such valuation. It is understood that “carbon credit” is intended to mean any tradable carbon unit or tradable commodity that assigns a value to CO₂ equivalents or GHG emissions or a reduction thereof.

It is understood that there are currently at least two exchanges for carbon valuation units: the Chicago Climate Exchange and the European Climate Exchange. The Chicago Climate Exchange has named its carbon valuation units “CCX Certified Financial Instruments,” while the European Climate Exchange has designated their units as “Emissions Reduction Units.” It is understood that “carbon credits” as used herein is intended to encompass these instruments or units and any other such valuation units. Furthermore, it is understood that certain quotas have been established by individual countries and further amongst multiple countries (by treaty or agreement) relating to the amount of GHG emissions or other environmentally damaging substances that countries and businesses can produce. One example of a multiple country agreement is the Kyoto Protocol. In these types of carbon quota regimes or agreements, each business or entity or country can compare its emissions to its quota to determine whether it has a credit surplus (because its emissions were below its quota) or it has a credit debt (because its emissions exceeded its quota), and act accordingly. While the various embodiments of systems and methods relating to the tracking and/or management of carbon valuation described herein are discussed mainly in the context of tracking and managing carbon credits, it is understood that these embodiments are intended to track or manage any type of carbon valuation.

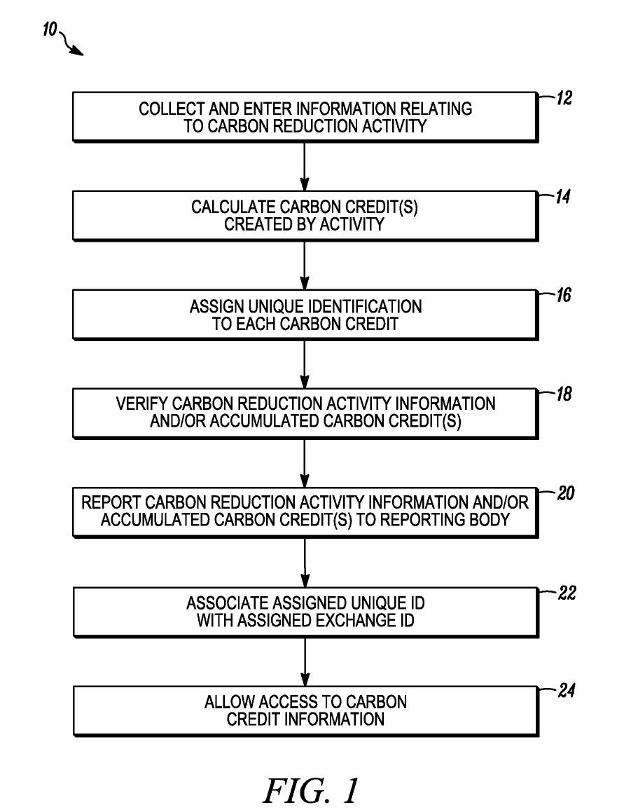

According to one embodiment, one method and system of tracking and managing carbon credits 10 or any other tradable carbon unit or carbon valuation for an enterprise and an entire market is set forth in FIG. 1. It is understood that this method and system can be performed on the basis of a site, an enterprise, or an entire market for any type of tradable carbon unit. It is also understood that the methods and systems described herein are not limited to tracking and/or management of carbon valuation such as carbon credits or the climate exchanges described herein and can be used to track and manage any type of credit or other carbon valuation (such as a carbon tax) relating to GHG emissions or any other activities that are carbon-related or otherwise have an impact on the environment.

In one implementation, the system provides for collecting and entering into the system information relating to any action resulting in the creation of a carbon credit or other carbon valuation unit (block 12). According to one embodiment, the information is saved as a record in a database. The carbon credit(s) created by the activity is/are then calculated (block 14). In one embodiment, the system has software to perform the calculation. In addition, each carbon credit or other carbon valuation unit is assigned a unique identification (“unique ID”) (block 16). In one implementation, the unique ID is added to the appropriate record in the database. The method, according to an alternative embodiment, can also include a verification step (block 18). That is, a person or entity, such as a third-party entity for example, performs a verification of the carbon reduction activity information and/or the carbon credit(s) accumulated from the carbon reduction. In a further alternative embodiment, the method can also include a reporting step (block 20). In this step, the system is configured to report the calculated carbon credit(s) to the appropriate reporting body.

The method can also include associating the assigned unique ID (as described above) with an assigned exchange identification associated with the carbon credit (block 22). Finally, the carbon credit information is made available in the system for tracking any carbon credit included in the system database (block 24). That is, when an interested party (perhaps a potential purchaser of the credit or an appropriate person at the exchange) wants to verify the validity of the carbon credit or access any information relating to the credit, the system can be accessed to generate a report or otherwise provide the information.

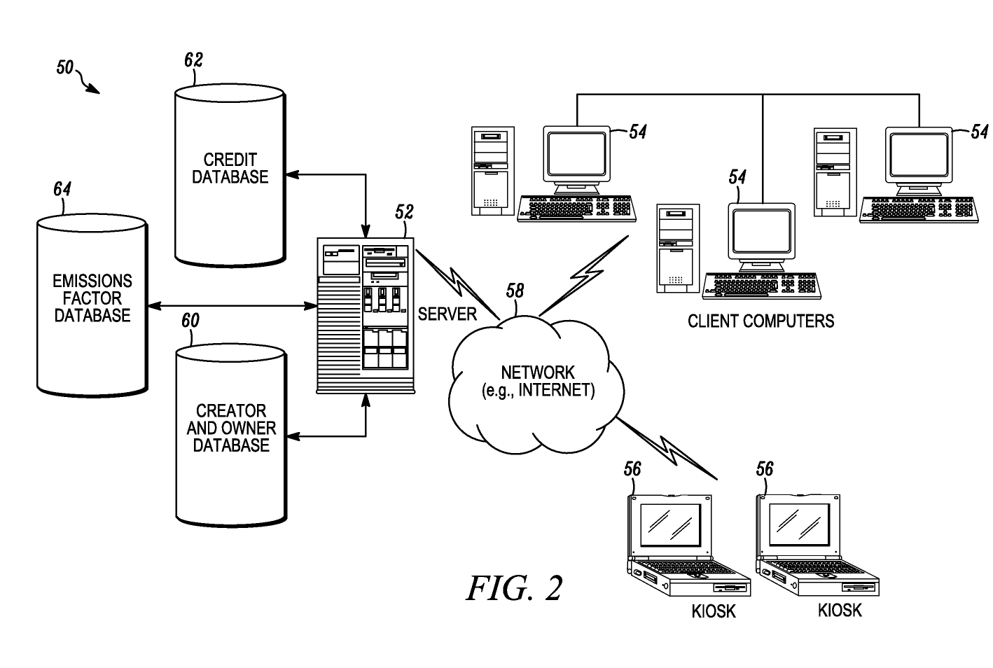

FIG. 2 depicts a schematic diagram of one embodiment of a network-based system for calculating, tracking, and/or managing carbon valuation for one or more pieces of equipment, one or more sites, one or more regions, an entire enterprise, or within the context of a carbon credit market. Further systems that could be utilized with the tracking and management embodiments described herein are disclosed in co-pending U.S. patent application Ser. No. 09/883,779, entitled “Method and System for Managing Enterprise Assets,” filed on Jun. 18, 2001, which is hereby incorporated herein by reference in its entirety.

As shown in FIG. 2, the system 50 according to one embodiment can include a server 52 in communication with client computers 54 and/or kiosks 56 through a network 58. The client computers 54 and/or kiosks 56 can be located at one or more of the various distributed sites of a distributed enterprise or could be located at other locations, such as third party sites. “Client computers” as used herein shall mean any known type of processor or computer, and can also be referred to as site processors 54 or site computers 54. The system 50 allows a distributed enterprise or multiple enterprises or people to track and/or manage carbon credits in a credit market.

As further shown in FIG. 2, according to one implementation, the server 52 is in communication with at least one of a carbon credit database 62, a carbon credit creator and owner database 60, and, in some embodiments, an emissions factor database 64. According to one embodiment, the carbon credit database 62 contains information regarding each carbon credit or portion thereof Further, the carbon credit creator and credit owner database 60 contains various information regarding people and/or entities that created the carbon credit and/or own or have owned the credit. The emissions factor database 64 contains information relating to emissions factors and other values and inputs that are used in various emissions calculations.

Alternatively, various embodiments of the system described herein can have separate databases for various different kinds of credit information. In a further alternative, all of the data are maintained in a single database.

It is understood that the server or central processor 52 (also referred to herein as an “enterprise processor”) can be any computer known to those skilled in the art. In one embodiment, the central processor 52 includes a website hosted in at least one or more computer servers. It is understood that any system disclosed herein may have one or more such server 52 and that each server may comprise a web server, a database server and/or application server, any of which may run on a variety of platforms.

According to one embodiment, the enterprise processor or processors 52 comprise a central processor unit (“CPU”) and main memory, an input/output interface for communicating with various databases, files, programs, and networks (such as the Internet), and one or more storage devices. The storage devices may be disk drive devices or CD-ROM devices. The enterprise processor 52 may also have a monitor or other screen device and an input device, such as a keyboard, a mouse, or a touch sensitive screen. Some non-limiting commercial examples of servers that could be used with various embodiments disclosed herein include Dell 2950, Sun Solaris, HP 9000 series, and IBM x3000 series.

In one implementation, the central processor 52 includes software programs or instructions that run on the server-side to process requests and responses from a client computer 54. These software programs or instructions send information to the client computer 54, perform calculation, compilation, and storage functions, transmit instructions to the client computer 54, and generate reports. It is understood that any embodiment of the systems disclosed herein that provide for data collection, storage, tracking, and managing can be controlled using software associated with the system. It is further understood that the software utilized in the various embodiments described herein may be a software application or applications that are commercially sold and normally used by those skilled in the art or it may be a specific application or applications coded in a standard programming language.

It is further understood that the software can be any known software for use with the systems described herein to track, calculate, and manage any carbon valuation units as described herein. For example, as described in further detail herein, various embodiments of the systems described herein could have any one or more of software for tracking and/or managing carbon credits, including the creation and ownership history of each credit, allowing access to such information and generating reports and other forms of summary information based on such information.

The central processor 52 allows access by the client processor 54 to various network resources. In one embodiment, the central processor 52 also has access, via the network 58 or some other communication link, to external data sources that may be used to keep the information in the server current. In a further alternative, the central processor 52 can also be in communication via the network 58 with various other systems such as, for example, one or more systems associated with one or more exchange entities or one or more systems associated with one or more verification entities. Such communication connections make it possible for the software present on the server 52 to retrieve, send, or exchange information with one or more other systems. In one implementation, a number of computers 54 may be connected to the server at any given time, and therefore a number of users may utilize the system simultaneously.

In the system 50, generally, carbon credit data or any other type of information entered into the system 50 via a client computer or processor 54 is received by the server 52 and stored in the credit database 62. Alternatively, it can be stored in any of the appropriate databases of the system.

The databases 60, 62, 64 serve as the inputs to and information storage for the management and tracking system 50, which utilizes software to process the information as described below and generates any one or more of notifications, reports, and/or instructions to a user or a third party system.

According to one embodiment, the databases 60, 62, 64 may be of any type generally known in the art. The databases 60, 62, 64 may be integral to the central processor 52 or they may be accessible to the central processor 52 through a computer network or other suitable communication link. In one embodiment, the databases 60, 62, 64 are comprised of a plurality of database servers, some of which are integral to the central processor 52, and some that are located remotely from the central processor 52. Some non-limiting commercial examples of databases that could be used with various embodiments disclosed herein include Oracle 9i, Oracle 10g, Microsoft SQL Server, PostSQL, and Ingress.

According to one embodiment, the carbon credit information stored in the credit database 62 can include any relevant information relating to the carbon credit and the asset, site, or enterprise that caused its creation. For example, the carbon credit information can include, but is not limited to, the unique ID for each credit, an original value for the credit, a description of the carbon reduction activity that created the credit(s), verification information relating to the carbon reduction activity, any certification information relating to the carbon reduction information, and ownership information relating to the credit, or any other kind of information relating to a piece of equipment.

In one embodiment, the description of the carbon reduction activity might include specific information about the reduction in CO₂ equivalent emissions or materials, the method of the reduction, the amount of the reduction, the asset(s), site(s), or enterprise(s) involved in the reduction, and any other information relating to the activity that created the credit. In a further embodiment, the verification information could include any information relating to the verification of the carbon reduction activity, including copies of invoices, contact information for verification personnel, contact information for the enterprise involved in the carbon reduction and/or appropriate personnel within the enterprise, or any other such information that may provide some verification of the reduction and credit creation. In addition, the verification information can include information relating to the equipment or site involved in the carbon reduction, the type of reduction, the material or gas that is the subject of the reduction, the actual reduction amount, and, in one alternative, on-going reduction for reduction activities occurring over a predetermined period of time. According to one embodiment, the verification information can include any information that is separate from the carbon reduction or carbon valuation calculation information or that is collected independently of such carbon reduction or carbon valuation calculation information.

In another implementation, the certification information can include any certification of the carbon reduction information provided by a certification or verification entity. Further, the ownership information can include a chain of title or chain of custody of the carbon credit, including the original owner and any subsequent owners.

The carbon credit information can be organized within the credit database 62 (or another appropriate separate database) or retrieved from the database 62 according to the unique ID of the credit, the creator of the credit, the owner of the credit, the equipment that created the credit, the site where the credit was created, or any other desired parameter. That is, the information can be stored or retrieved on a per-credit basis, a per-credit creator basis, a per-credit owner basis, a per-site basis, a per-asset basis, or any other basis.

As discussed above, the carbon credit creator and credit owner database 60 contains various information regarding people and/or entities that created the carbon credit and/or own or have owned the credit. In one implementation, the information can include the names of the people and/or entities, addresses, phone numbers, e-mail addresses, any other contact information, and any other information about the carbon credit creators and carbon credit owners that may be useful in tracking and/or managing any carbon credits.

In a further implementation as discussed above, the emissions factor database 64 contains information relating to emissions factors and other values and inputs that are used in various emissions calculations. For example, the database 64 can contain any emissions factors as defined elsewhere herein that are provided by various governmental agencies, including the eGRID factor and any other factors that may be used in emissions calculations. Further, the database 64 can also include other values such as the global warming potentials (which are defined and described in detail elsewhere herein) that are used in calculations to determine the amount of the reduction or destruction of emissions or CO₂ equivalent material.

Returning to the collection and entering of any activity resulting in the creation of a carbon credit as set forth in block 12 of FIG. 1, it is understood that any number of different activities on an asset level, a site level, an enterprise level, or even across multiple enterprises could result in the creation of a carbon credit or other type of carbon valuation unit. Essentially, any activity that reduces greenhouse or CO₂ equivalent gas emission or material levels, including reduction of GHG emissions, reduction of CO₂ equivalent emissions, reduction of CO₂ equivalent materials, destruction of any ozone depleting substances, or any other reduction in such environmentally damaging gases or materials could result in the creation of one or more carbon credits or even a portion of one. For purposes of this application, “carbon reduction,” “carbon reduction activity,” or “carbon reduction project” is intended to mean any such activity that reduces GHG emissions, GHG levels, CO₂ equivalent emissions, CO₂ equivalent materials, or any other emissions or materials that are environmentally damaging. For example, an enterprise may complete a carbon reduction project to reduce emissions at one or more sites. Additional exemplary activities that result in one or more carbon credits or other carbon valuation units will be discussed in further detail below. In each case, any information relating to the carbon reduction activity (also referred to herein as “carbon credit information”) is collected and entered into the system. In one embodiment, as mentioned above, the carbon credit information relating to one activity is saved as a record in a database.

In another exemplary embodiment, a site or enterprise could maintain their GHG emissions below a set emissions quota, and thereby accumulate credits for the amount of emissions below the quota.

In another example, GHG emissions could be reduced for some predetermined period of time. In such an example, carbon credits can be accumulated over time by maintaining a predetermined reduced emissions level over the preset period. Typically, this type of long-term reduction requires verification. According to one embodiment, the present system allows for such verification as set forth in additional detail below.

A further example relates to destruction of a regulated substance such as an ozone depleting substance (“ODS”). In one embodiment, a person or entity can earn carbon credits by destroying an ODS or other regulated substance. Various examples of regulated substance destruction are described in further detail in U.S. application Ser. No. 12/252,265, filed on Oct. 15, 2008 and entitled “Method and System for Tracking and Managing Destruction, Reconstitution, or Reclamation of Regulated Substances,” which is hereby incorporated herein by reference in its entirety.

It is understood that any other known activity that reduces GHG emissions or other CO₂ equivalent emissions or otherwise reduces the presence or emission of any CO₂ or CO₂ equivalent material can be performed to create one or more carbon credits and thus be considered a carbon reduction activity. Various examples of carbon reduction activities are set forth in U.S. application Ser. No. 12/233,897, filed on Sep. 19, 2008 and entitled “Method and System for Tracking and Reporting Emissions,” U.S. application Ser. No. 12/042,917, filed on Mar. 5, 2008 and entitled “Method and System for Tracking and Managing Various Operating Parameters of Enterprise Assets,” and U.S. application Ser. No. 12/252,265, filed on Oct. 15, 2008 and entitled “Method and System for Tracking and Managing Destruction, Reconstitution, or Reclamation of Regulated Substances,” all of which are hereby incorporated herein by reference in their entireties. It is further understood that any emissions or CO₂ equivalents reduction or destruction can be calculated by tracking such reduction or destruction by any system or method, including the various exemplary tracking and/or managing embodiments set forth in the above incorporated U.S. application Ser. Nos. 12/233,897, 12/042,917, and 12/252,265.

The information relating to the carbon reduction is then entered into the system (see block 12 in FIG. 1). According to one embodiment, the information entry can be accomplished manually at a client computer 54 or kiosk 56 or alternatively can be accomplished by scanning the information into the system at a scanner (not shown) that is in communication with the server 52 via the network 58 or is directly connected to the server 52. In a further alternative, any system embodiment disclosed herein (such as system 50, for example), can be in communication over the network 58 with a processor or system at the appropriate exchange or some other entity tasked with tracking and/or verifying CO₂ equivalent reductions and carbon credit creation such that verified information relating to the activity can be transmitted from the other entity to the server 52. For example, any system embodiment disclosed herein can be in network communication with any tracking and/or management system such as any such system as described in any of U.S. application Ser. Nos. 12/233,897, 12/042,917, and 12/252,265, incorporated above.

According to another implementation, the various processes for collecting and storing information can be implemented using or in conjunction with a method or system for surveying information. One example of such a system is disclosed in co-pending U.S. patent application Ser. No. 10/771,090, entitled “Site Equipment Survey Tool,” filed on Feb. 3, 2004, which is incorporated herein by reference in its entirety.

As described above with respect to FIG. 1, the various embodiments described herein also provide for calculating the carbon credit(s) created by the activity (block 14). In one embodiment, the system 50 utilizes software, such as software located on the server 52, to calculate the credit amount (the number of credits earned as a result of the activity).

To best understand how the various embodiments disclosed herein can be used to calculate the carbon credits created by a particular carbon reduction project, it is helpful to understand the calculation of reduction in emissions or CO₂ equivalents, and the calculation of any carbon credits created by the reduction.

In one aspect, the amount of emissions is calculated by inputting into an appropriate equation emissions or reduction information and emission factors appropriate to the source for which an emission production amount is to be calculated. According to one embodiment, the amount of emissions produced is calculated in the system using the following general equation:

Emissions Produced=Emission Activity [weight, volume, distance, or duration]×Emission Factor [Metric Ton CO₂/(weight, volume, distance, or duration)]

For purposes of the present application, “emission factors” are representative values that relate the quantity of emissions released to the atmosphere with an activity associated with the release of emissions. These factors are expressed as the weight of emission (typically Metric Ton of CO₂ divided by a unit weight, volume, distance, or duration of the activity producing the emission). Emission factors are made available through various governmental agencies, such as, for example, the Intergovernmental Panel on Climate Change (“IPCC”) or Environmental Protection Agency. Because the emission factors fluctuate, in some embodiments, they are updated on a periodic basis.

One example of an emissions factor is the factor associated with indirect emission sources, such as those sources provided by utilities. One common term for such a factor is the “eGRID factor.” This factor is assigned to an energy provider or utility based on the emissions created by the provider, which is influenced by the sources of the energy.

Further emissions totals can be calculated by the system using any of the equations and factors provided in the GHG protocol by the World Resources Institute (www.ghgprotocol.org), which is hereby incorporated herein by reference in its entirety. Plus, further calculations, equations, and emissions factors relating to GHG emissions are set forth in the California Climate Action Registry General Reporting Protocol, Version 2.1, published in June, 2006, which is hereby incorporated herein by reference in its entirety.

As mentioned above, the embodiments disclosed herein relating to tracking and/or managing carbon credits further includes tracking reductions in CO₂ equivalents. It is understood that a “CO₂ equivalent” is a quantity that describes, for a given mixture and amount of greenhouse gas, the amount of CO₂ that would have the same global warming potential (“GWP”), when measured over a specified timescale. Thus, when the GHG or substance being tracked is a gas other than CO₂ (such as, for example, CH₄ or N₂O), this calculation can be used to determine a functionally equivalent amount of CO₂ for that gas or substance. According to one embodiment, the conversion is accomplished on the basis of the respective GWPs of the CH₄ and/or N₂O emissions. “GWPs,” as used herein, are representative values used to compare the abilities of different greenhouse gases to trap heat in the atmosphere. The GWP values provide a construct for converting emissions of various gases into a common measure denominated in CO₂ equivalent and is provided by the IPCC. It is understood that every greenhouse gas and every regulated substance as defined herein has a GWP value that can be used (along with the amount of the GHG or substance) to calculate the CO₂ equivalents for the GHG or substance. In one embodiment, the conversion equation is set forth as follows: Metric Tons of CO₂e=Metric Tons of Non-CO₂e GHG×GWP.

In alternative embodiments, other measures and other calculations could be used to calculate CO₂ equivalents or other types of equivalents. In a further embodiment, emissions can be measured and tracked without calculating any equivalents.

Additional detail relating to calculations of reductions in emissions or equivalents, including conversion calculations, can be found in U.S. application Ser. Nos. 12/233,897, 12/042,917, and 12/252,265, which are incorporated by reference above.

With the above background relating to reduction and carbon credit calculations in place, it is appropriate to discuss how the calculations can be performed according to various embodiments of the systems and methods disclosed herein.

In one implementation, the system software is configured to prompt a user to enter the appropriate information about the amount of reduction in GHG emissions or other CO₂ equivalent reduction (such as appropriate emissions amounts and perhaps emissions factors, etc.), and/or appropriate information necessary to calculate the carbon credits created as a result of the reduction. The software then utilizes the entered information along with the appropriate formulas or calculations to determine the number of carbon credits accumulated. That is, the software, according to one embodiment, can perform any of the calculations described above based on the above equations (or other known equations) to determine the amount of the reduction in emissions or CO₂ equivalent substances for a particular source, site, enterprise, or multiple enterprises. Then the software can utilize that information to calculate the carbon credits created by the reduction.

Alternatively, the system software is configured to access the appropriate information relating to emissions factors, GWPs, or any other values in the emission factors database 64 and utilize that information to perform the above calculations. In this embodiment, the database 64 contains the relevant values or factors needed for the appropriate calculations. The software accesses the appropriate values or factors as discussed above and use them to calculate the reduction in emissions or CO2 equivalent materials and then further to calculate the credits earned as a result of the reduction. In a further variation of this embodiment, the database 64 can be updated—either automatically or manually by a user—with new or revised values or factors as those become available.

In a further alternative, the system software is configured to access the appropriate information via one or more external systems or data sources. In this embodiment, the server 52 has access—via the network 58 or some other communication link—to external data sources or other systems such as the data sources or systems of the entities that provide the emissions factors or other values, the entities that provide the carbon credit values, or any other entities or sources having information useful for the calculations of any reduction in emissions or CO2 equivalent materials and any credits earned as a result of the reduction. Alternatively, any one or more of these entities (or any user at these entities) can enter any of this information into any embodiment of the systems and methods disclosed herein via a client computer 54. Thus, the software obtains or receives the appropriate information as discussed herein and performs the above calculations based on that information.

As discussed above with respect to FIG. 1, after calculation of the carbon credits created by the activity, various embodiments of the system provide for assigning a unique ID to each carbon credit (block 16). In one embodiment, the system has software configured to write a unique ID to the record of each carbon credit or portion thereof. Alternatively, a unique ID can be attached to or otherwise associated with each carbon credit in the database 62 according to any known method. In one implementation, the unique ID for each credit gives the credit a trackable identity that allows the system provide for tracking the full history of the credit, including any creation information, verification information, certification information, and/or ownership information, along with any other information available in the system regarding the credit.

As discussed above with respect to FIG. 1, the method and system embodiments disclosed herein can also include a verification step (block 18). It is understood that various carbon valuation regimes require verification of various steps of carbon reduction activities and carbon credit accumulation, including verification of the carbon reduction, verification of the accumulated carbon credit(s), including the amount thereof, and/or verification of the ownership of the carbon cardit(s). As such, various embodiments of the methods and systems disclosed herein provide for tracking and verification of the carbon reduction activity information, the carbon valuation calculation, and/or the carbon credit ownership information (block 18). In one embodiment, verification can include review of carbon reduction information, the carbon valuation calculation information, and/or the carbon credit ownership information. In further embodiments, verification can include comparison of the carbon reduction information in the system with verification information

According to one implementation, the system and method embodiments disclosed herein can include software that automatically performs the verification steps as described herein. For example, in one embodiment, certain embodiments have software that is programmed to provide automatic verification of the carbon reduction, the carbon credits, and/or the carbon ownership, including recurring verification when desired. Alternatively, the embodiments can have software that can prompt a user to instruct the system to begin a particular verification, such as a comparison process as described above. In a further alternative, the software can be configured to allow the user to select among several different verification processes.

In another implementation, the calculated amount of reduction is entered into and stored in the system, and the system software provides for automatically checking the actual reduction amount via a third party, verification information, or an automatic sensor for the asset, site, region, or enterprise that is the subject of the promised reduction and comparing that actual reduction amount against the predetermined amount. In one embodiment, the software is further configured to transmit a notification to a user, the enterprise, or a verification body relating to the verification performed by the software.

In a further implementation, various embodiments can also provide for certification of the verified carbon reduction activity information and/or the carbon valuation calculation. That is, if the verification step is successful or otherwise satisfies any predetermined verification parameters, the carbon reduction information can be designated as certified. In certain embodiments, the systems can also have software that is configured to automatically certify the verified information. According to one implementation, the software can be configured to mark or designate the carbon reduction information as certified.

Alternatively, the methods and systems disclosed herein can include any necessary verification steps, and can further include any certification steps.

As discussed above with respect to FIG. 1, another step, according to various embodiments herein, relates to reporting the calculated carbon credit(s) (block 20). There are currently various reporting bodies or entities to which enterprises or entities can voluntarily report their carbon reduction activities and/or the carbon credit(s) accumulated thereby. In one embodiment, the systems and methods herein are configured to report the carbon reduction activities and/or accumulated carbon credit(s) to a credit exchange as described elsewhere herein. Alternatively, the systems and methods herein are configured to report the activities or accumulated credit(s) to a reporting entity or body such as the Consolidate Emissions Reporting Schema (which is operated by the EPA), the California Climate Action Registry, or the Climate Registry.

In one embodiment, various systems and methods as described herein include software configured to transmit or report the appropriate information to the reporting body or exchange. In one implementation, the software automatically transmits the information to the body or exchange. The software can transmit the information in the form of a report according to any report embodiment described elsewhere herein. Alternatively, the system can be in communication with the system of the reporting body or exchange over a network (such as, for example, the Internet) and transmit the information to the system over the network. In a further alternative, the software can be configured to provide prompts to a user to select when and how to report the information to a reporting body or exchange. In yet another alternative, the software can be configured to provide prompts to the user to select the reporting body or exchange to which to transmit the information.

Another step discussed above with respect to FIG. 1 is the association of the unique ID with the exchange ID. It is understood that when an appropriate activity is reported to a carbon exchange such as the Chicago Climate Exchange or the European Climate Exchange or to a reporting body such as those described above, the exchange or reporting body typically assigns an identification to the carbon credit. This identification shall be referred to herein as the “exchange identification” or “exchange ID.” In one embodiment, the exchange identification is entered into the system as part of the carbon credit information relating to this particular carbon credit and is associated with the unique ID of the carbon credit such that the credit can be tracked based on its unique ID or its exchange ID. This association of the unique ID and the exchange ID extends the trackable identity of carbon credit such that any person or entity with either the unique ID or the exchange ID for the credit can track the full history of the credit, including any of the information described above.

According to one implementation, software present on the server of the system can prompt the user to enter the appropriate exchange ID and automatically associate the exchange ID with the unique ID. Alternatively, in embodiments in which the system is in communication with one or more exchange systems, the software automatically requests and/or retrieves the exchange ID from the exchange system and automatically associates the exchange ID with the unique ID.

As discussed above with respect to FIG. 1, once the carbon credit information has been entered into the system, the carbon credit(s) have been calculated, the unique ID assigned, and the exchange ID associated therewith, the system is configured to make some or all of the information relating to the carbon credit(s) available to anyone with access to the system.

In one embodiment, any individual can access the credit information relating to any individual carbon credit, a portion thereof, or a group of credits, via a client computer 54 or kiosk 56 that can be located anywhere and is in communication with the server 52 over a network 58 such as the Internet. The individual can be a potential purchaser, an individual involved in verification (such as, for example, an employee of a verification entity), an individual at an exchange, an individual who owns the credits or who is an employee of an entity that owns the credits, or any other user or individual interested in tracking one or more carbon credits who can access the system.

To limit access to authorized users, in one embodiment, the system requires a password to access the system via any client computer or kiosk or other known type of access point. That is, the system prompts the user to enter a predetermined password before allowing the user to access the system. In one embodiment, the system creates a separate and unique password for each user. Alternatively, one password can be used by more than one user.

In a further embodiment, the system can also provide for various types of users to have distinct levels of access that differ from user to user. That is, the information accessibility can be specifically tailored or controlled based on the user, such that each user can only access the information appropriate for that user's level of access. For example, according to one implementation, an appropriate user or employee at an entity that owns certain carbon credits has full access to all information relating to those carbon credits that the user owns, while that user's access to other carbon credit information may be restricted in some fashion or completely prohibited. Similarly, for a user who is a verifier or works for a verification entity, the system may allow that user access only to the appropriate information relevant for verification and only for those carbon credits that the user is tasked with verifying. Such predetermined access levels can be established by an administrator and entered into the system such that the user need only provide a username and password when prompted by the system at a client computer and the user is automatically provided with the appropriate access. In one embodiment, the system has software configured to provide and control the predetermined access levels. In a further implementation, the software can also generate the appropriate usernames and/or passwords for each user and associate the appropriate access level for each user with the user's username and/or password.

In one embodiment, the predetermined access level for any particular user can be controlled by specifying securable or configurable attributes for each system user. These attributes can be specified by a system administrator who, in one embodiment, is prompted by software within the system to enter the attributes for a particular user, thereby determining the user's access level. In one alternative, the attributes are pre-defined based on the type of user. That is, the user can have access to certain predetermined information based on the user's role, which is entered into the system. For example, if the user is involved in verification, that information can be entered into the system and the appropriate software can identify the level of access of that user based on the user's role as a verifier or employee of a verification entity.

In yet another implementation, the system can also provides for various types of users to have distinct rights to system tools and/or capabilities. In contrast to the defined levels of access, which determine a user's access to the information stored in the system, the rights to tools and capabilities relates to the user's ability to utilize various capabilities of the system such as generating reports, entering information, editing information, etc. For example, in one embodiment a user who owns carbon credits (or works for an entity who does) might have rights to enter information relating to the carbon reduction resulting in the carbon credits, but may not have rights to edit any such information after entry. In another example, a user who works for a verification entity might have rights to generate reports relating to verification or otherwise utilize any functions or capabilities of the system to generate one or more summaries of information stored or processed in the system relating to verification. In a further example, any person or entity interested in purchasing certain carbon credits might have rights to generate certain reports or other forms of information summaries relating to the carbon credits and the related carbon reduction.

As with the predetermined access levels, the user's rights to system tools and/or capabilities can be controlled or determined based on user attributes. For example, the attributes can be specified by a system administrator who, in one embodiment, is prompted by software within the system to enter the attributes for a particular user, thereby determining the user's rights to system tools and capabilities. In one alternative, the attributes are pre-defined based on the type of user. That is, the user may have rights to certain system tools and/or capabilities based on the user's role, which is entered into the system. For example, if the user is involved in verification, that information can be entered into the system and the appropriate software can identify the rights of that user to various tools and capabilities based on the user's role as a verifier or employee of a verification entity.

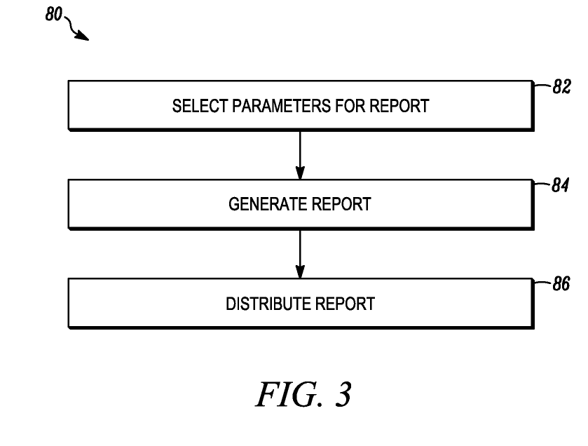

FIG. 3 depicts one method of generating a report 80, according to one implementation. This particular method includes selecting the parameters for the desired information (block 82), generating a report on the basis of the selected parameters (block 84), and making the report available for dissemination (block 86).

Selecting the parameters for the desired information (block 82) can include selection of one or more of any number of different parameters. In one implementation, the user selects the type of information for the report. For example, a verifier or user employed by a verification entity may select all carbon reduction activity information associated with one or more carbon credits. In another example, a user may select all information associated with one or more carbon credits, including the carbon reduction activity, the ownership information for the carbon credit(s), etc. In a further example, a report request may be made for all of an enterprise's carbon credits. Alternatively, a report request may be made on the basis of site location, source type or subtype, or any combination thereof. In addition, the user can select the time period for the relevant information. It is further understood that the user can define the parameters of the report in any known fashion.

Typically, a report request is initiated by a user located at a client computer or kiosk or other system entry point similar to those depicted in FIG. 2. Alternatively, the request can be initiated by anyone with access to the system. For example, the request could be requested by any user with access to the system over the Internet.

Upon initiation, according to one embodiment, the server utilizes the parameters provided by the user to retrieve the appropriate information from the one or more databases and generate the report (block 84). Subsequently, the report can be made available for dissemination (block 86). In some embodiments, the report is only made available for dissemination internally within an enterprise or entity. For example, the report may be automatically distributed to predetermined recipients within the entity or enterprise. Alternatively, the report may, in accordance with applicable laws and regulations, be made available for dissemination to several individuals or entities, such as, for example, local, state, or federal governmental agencies. In one embodiment, the report is generated and distributed in hardcopy. Alternatively, the report is generated and distributed electronically, such as via e-mail, facsimile, or a webpage. In a further alternative, the report can be generated in any known form and any known fashion.

Further, alternative methods and systems disclosed herein include the generation of reports for purposes of verification. In one exemplary embodiment, the report is generated containing verification information to be transmitted to a third party observer or verification entity according to the report generation capabilities described above.

In accordance with one implementation, any embodiment of the systems and methods for tracking carbon credits as set forth herein can also be used in conjunction with any of various other systems, including any system for tracking and/or managing GHG emissions and/or energy consumption across assets, sites, and/or enterprises (such as those systems disclosed in U.S. application Ser. Nos. 12/233,897, 12/042,917, which are incorporated by reference above), any system for tracking and/or managing the destruction or disposal of any environmentally damaging gases or materials across assets, sites, and/or enterprises (such as those systems disclosed in U.S. application Ser. No. 12/252,265, which is incorporated by reference above), and any other similar system or systems, such as those for tracking and/or managing equipment costs, ownership costs, etc.

Although certain inventions have been described herein with reference to preferred embodiments, persons skilled in the art will recognize that changes may be made in form and detail without departing from the spirit and scope of those inventions.

What is claimed is:

1. A network-based carbon credit tracking system, the system comprising:
(a) a central processor accessible on a computer network;
(b) a database in communication with the central processor, the database configured to store carbon credit information relating to each carbon credit or each portion thereof being tracked by the system, the carbon credit information comprising at least carbon reduction information relating to each carbon credit or portion thereof;
(c) a client processor in communication with the central processor, the client processor configured to allow a user to input or access any portion of the carbon credit information;
(d) carbon credit calculation software associated with the central processor, the carbon credit calculation software configured to calculate a total number of carbon credits based on a carbon reduction activity;
(e) identification software associated with the central processor, the identification software configured to assign a unique identification to each carbon credit or portion thereof; and
(f) report software associated with the central processor, the report software configured to generate a report relating to the carbon credit information.

2. The system of claim 1, wherein at least a portion of the carbon credit information is entered into the system via the client processor.

3. The system of claim 1, wherein the central processor is in communication with an external system via the computer network.

4. The system of claim 3, wherein at least a portion of the carbon credit information is entered into the system via the external system.

5. The system of claim 3, wherein carbon credit calculation software is configured to calculate a total number of carbon credits based at least in part on information from the external system.

6. The system of claim 1, further comprising verification software associated with the central processor, the verification software configured to track and verify the carbon reduction activity information.

7. The system of claim 6, wherein the verification software is further configured to certify the carbon credits and/or the carbon reduction activity information.

8. The system of claim 1, wherein the report software is further configured to transmit the report to a reporting body, wherein the report comprises carbon reduction activity information or carbon credit information.

9. The system of claim 1, further comprising association software configured to associate the unique identification with an assigned exchange identification.

10. The system of claim 1, wherein the report software is configured to generate the report in response to a user request at a client processor.

11. A network-based carbon credit tracking system, the system comprising:
(a) a central processor accessible on a computer network, wherein the central processor is in communication with an external system via the computer network;
(b) a database in communication with the central processor, the database configured to store carbon credit information;
(c) carbon credit calculation software associated with the central processor, the carbon credit calculation software configured to calculate a total number of carbon credits based at least in part on a portion of the carbon credit information;
(e) identification software associated with the central processor, the identification software configured to assign a unique identification to each carbon credit or portion thereof; and
(f) report software associated with the central processor, the report software configured to generate a report relating to the carbon credit information.

12. The system of claim 11, wherein at least a portion of the carbon credit information is obtained from the external system to the tracking system via the computer network.

13. The system of claim 12, wherein at least a portion of the carbon credit information is transmitted from the external system to the tracking system via the computer network.

14. The system of claim 12, wherein at least a portion of the carbon credit information is retrieved from the external system by the tracking system via the computer network.

15. The system of claim 11, wherein at least a portion of the carbon credit information is exchanged with the external system via the computer network.

16. The system of claim 11, wherein carbon credit calculation software is configured to calculate a total number of carbon credits based at least in part on information from the external system.

17. The system of claim 11, wherein the external system is at least one of an exchange entity system, a verification entity system, or a reporting body system.

18. The system of claim 11, further comprising a client processor in communication with the central processor, the client processor configured to allow a user to instruct the central processor to perform an operation.

19. The system of claim 11, wherein the carbon credit calculation software is further configured to access information from an external system to calculate the total number of carbon credits.

20. A network-based carbon credit tracking system, the system comprising:
(a) a central processor accessible on a computer network, wherein the central processor is in communication with an external system via the computer network;
(b) a database in communication with the central processor, the database configured to store carbon credit information relating to each carbon credit or each portion thereof being tracked by the system, the carbon credit information comprising at least carbon reduction information and ownership information relating to each carbon credit or portion thereof;
(c) a client processor in communication with the central processor, the client processor configured to allow a user to input or access any portion of the carbon credit information;
(d) carbon credit calculation software associated with the central processor, the carbon credit calculation software configured to calculate a total number of carbon credits based on a carbon reduction activity;
(e) identification software associated with the central processor, the identification software configured to assign a unique identification to each carbon credit or portion thereof; and
(f) report software associated with the central processor, the report software configured to generate a report relating to the carbon credit information.
